(19) United States
(12) Patent Application Publication
(10) Pub. No.: US 2008/0174542 A1
(43) Pub. Date: Jul. 24, 2008

(54) LIQUID CRYSTAL DISPLAY DEVICE AND METHOD OF CONTROLLING THE SAME

(75) Inventor: Takashi Wada, Kumagaya-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/853,634

(22) Filed: Sep. 11, 2007

(30) Foreign Application Priority Data
Dec. 22, 2006 (JP) 2006-346477

(51) Int. Cl. G09G 3/36

(52) U.S. Cl. 345/102

(57) ABSTRACT

According to one embodiment, a liquid crystal display device including: a display unit configured to display an image, the display unit including an LCD panel and a backlight; an input unit at which an adjustment amount is input, the adjusting amount being used to adjust a contrast and a brightness of the image; and a control unit configured to adjust a brightness of the backlight and a contrast value of the LCD panel based on the adjustment amount, the brightness of the backlight being adjusted when the contrast value is maximum, the contrast value being adjusted when the brightness of the backlight is minimum.

### CROSS-REFERENCE TO RELATED APPLICATIONS

This application is based upon and claims the benefit of priority from Japanese Patent Application No. 2006-346477, filed Dec. 22, 2006, the entire contents of which are incorporated herein by reference.

### BACKGROUND

1. Field

One embodiment of the invention relates to a liquid crystal display device and a method of controlling the liquid crystal display device capable of unifying control of contrast and backlight brightness thereby to reduce power consumption and to restrict an increase in a black brightness.

2. Description of the Related Art

As a related art, there has been a liquid crystal display device and a liquid crystal display controlling method capable of simultaneously adjusting the contrast and brightness of the liquid crystal display device by a single operation using a pointing device (For example, see JP-A-11-73275)

This liquid crystal display device includes an LCD serving as a display unit on which an image is displayed; a pointing device for inputting x and y coordinate positions on the display screen of the LCD; and a pointing-device input processing program for converting the x and y coordinates designated by the pointing device into commands for setting the contrast of an LCD panel and brightness of a backlight. Therefore, this liquid crystal display device can adjust the settings of the contrast of the LCD panel and brightness of the backlight by a single operation by the designating operation using the pointing device.

However, in the conventional liquid crystal device, according to some adjustment values in the pointing device, for example, if the backlight brightness is set at the maximum value with the contrast being kept at the minimum value, although the brightness of the screen does not increase so greatly, power consumption of the backlight may increase; or otherwise, the brightness of the area (black brightness of LCD) which should be essentially black may increase and the contrast may further decrease.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a schematic view showing the external appearance of a liquid crystal display device according to an embodiment of this invention;

FIG. 2 is a block diagram showing the configuration of a liquid crystal display device according to the embodiment;

FIG. 3 is a block diagram showing the configuration of the LCD and a display control unit according to the embodiment;

FIGS. 4A to 4C are graphs showing an operation of the liquid crystal display device according to the embodiment;

FIG. 5 is a flowchart showing the operation of the liquid crystal display device according to the embodiment.

### DETAILED DESCRIPTION

Various embodiments according to the invention will be described hereinafter with reference to the accompanying drawings. In general, according to one embodiment of the invention, a liquid crystal display device including: a display unit configured to display an image, the display unit including an LCD panel and a backlight; an input unit at which an adjustment amount is input, the adjusting amount being used to adjust a contrast and a brightness of the image; and a control unit configured to adjust a brightness of the backlight and a contrast value (a value for adjusting the contrast) of the LCD panel based on the adjustment amount, the brightness of the backlight being adjusted when the contrast value is maximum, the contrast value being adjusted when the brightness of the backlight is minimum.

Referring to the drawings a detailed explanation will be given of the embodiment

(Configuration of the liquid crystal display device)

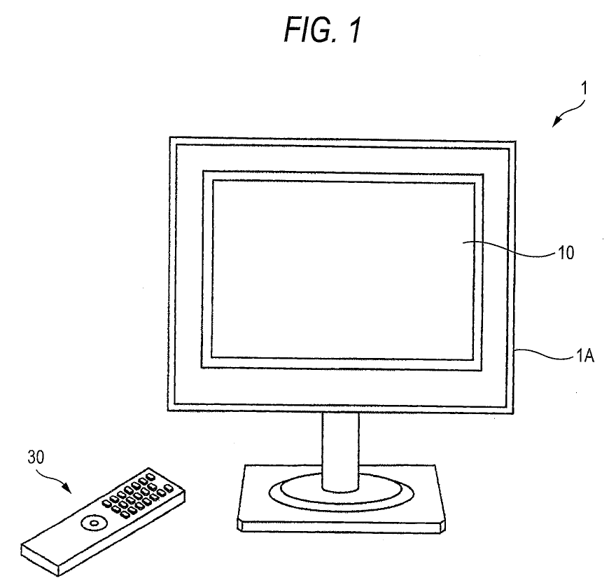

FIG. 1 is a schematic view showing the external appearance of a liquid crystal display device according to an embodiment of this invention.

A liquid crystal device 1 incorporates electronic components for image processing such as a tuner and decoder within a body 1A which internally process the video signal externally received; the video signal thus processed is produced by a display unit 10. The display unit 10 may be e.g. an LCD. The operation of the liquid crystal display device 1 is executed using a remote controller 30 having a plurality of operating switches.

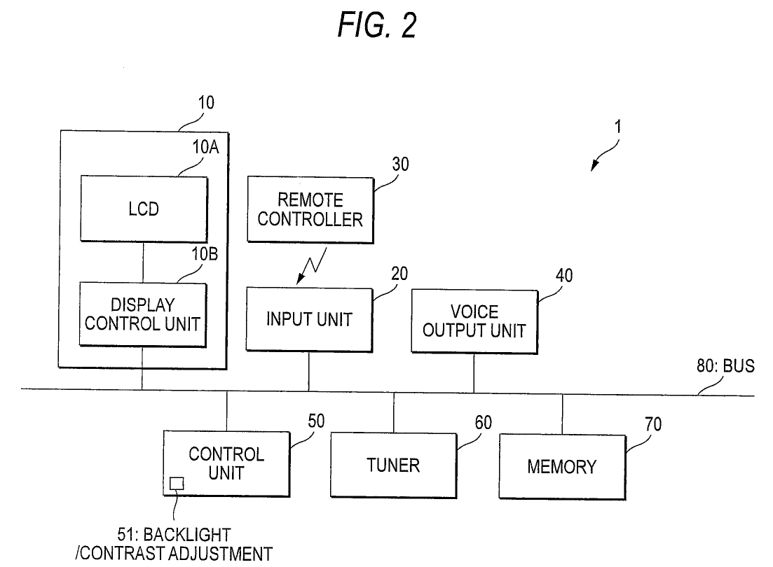

FIG. 2 is a block diagram showing the configuration of a liquid crystal display device according to the embodiment

The liquid crystal display device 1 includes a display unit 10 consisting of a display control unit 10B which receives a video signal produced from a tuner 60 described later and supplies the video signal after subjected to display control of e.g. brightness and contrast to a display area and an LCD 10A on which the output sent from the display control unit 10B is displayed; an input unit 20 which receives an operation signal transmitted from the remote controller 30 and transmits it to the control unit 50 described later, or transmits the operation signal to the control unit 50 through a plurality of switches equipped (not shown); a voice output unit 40 which receives an audio signal from the tuner 60 and outputs it as a voice; the control unit 50 for controlling the respective components of the liquid crystal display device 1; a tuner 60 which demodulates a video signal received through an external antenna (not shown); a memory 70 which temporarily stores the data being processed in the control unit 50; and a bus 80 which connects the respective components within the liquid crystal display device 1.

The control unit 50 includes a backlight/contrast adjustment 51 functioning as software for unifying management of the backlight and contrast of an input video signal when the input video signal produced from the tuner 60 is controlled by the display control unit 10B.

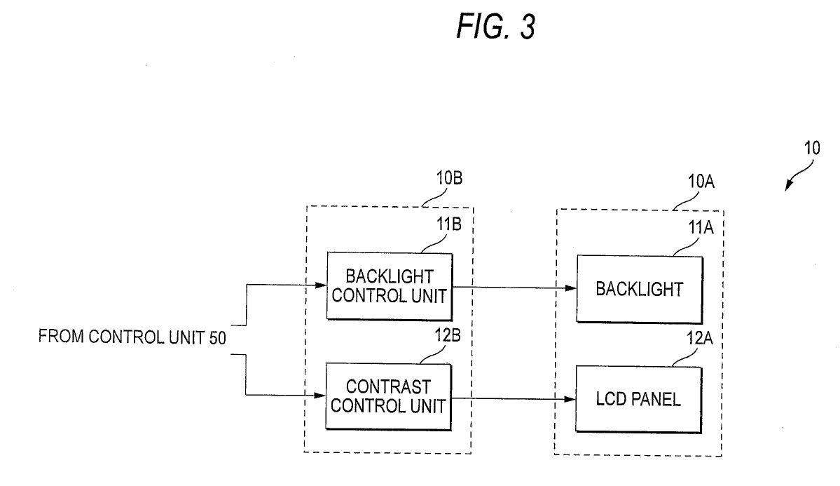

FIG. 3 is a block diagram showing the configuration of the LCD and display control unit according to the embodiment.

The LCD 10A includes a backlight 11A which is an LED or cold-cathode tube and an LCD panel 12A which displays an image when it is illuminated with the backlight 11A.

The display control unit 10B includes a backlight control unit 11B for controlling the brightness of the backlight 11A and a contrast control unit 12B for controlling the contrast of the LCD panel 12A.

(Operation)

The tuner 60 receives a video signal through an antenna externally connected (not shown). The tuner 60 demodulates the received video signal. The tuner 60 transmits the demodulated video signal to the display control unit 10B as an input video signal and also transmits an audio signal to the voice output unit 40. The display control unit 10B controls the input video signal on the basis of a predetermined setting and supplies the controlled video signal to the LCD 10A. The processing in the control unit 50 and the processing in the display control unit 10B are effectively executed by temporarily storing the information in the memory 70.

The operation for the setting in the display control unit 10B, e.g. brightness and contrast is executed using the remote controller 30 and input unit 30. The adjustment degree which is the contents of the operation is transmitted from the input unit 20 to the backlight/contrast adjustment 51 of the control unit 50. On the basis of the adjustment degree received, the backlight/contrast adjustment 51 supplies a control signal to the backlight control unit 11B or contrast control unit 12B. The control signal is supplied to the display control unit 10B to operate the backlight control unit 11B and contrast control unit 12B. The backlight control unit 11B controls the brightness of the backlight 11A and the contrast control unit 12B controls the contrast of the LCD panel 12A.

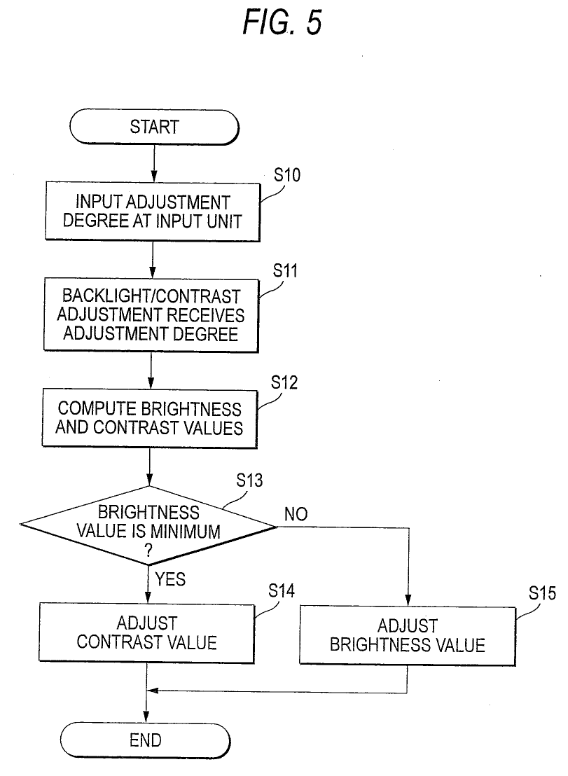

FIG. 5 is a flowchart showing the operation of the liquid crystal display device according to the embodiment.

First, the adjustment degree is supplied to the input unit 20 through the input unit 20 itself or remote controller 30 (S10). Next, when the backlight/contrast adjustment 51 receives the adjustment degree from the input unit 20, it computes the brightness value of the backlight 11A and the contrast value of the LCD panel 12A which correspond to the adjustment degree (S11). If the brightness of the backlight 11A is minimum (S13; Yes), the backlight/contrast adjustment 51 transmits the control signal to the contrast control unit 12B to adjust the contrast (S14). If the brightness of the backlight 11A is not minimum (S13; No), since the contrast value of the LCD panel 12A is in its maximum state, the backlight/contrast adjustment 51 transmits the control signal to the backlight control unit 11B to adjust the brightness value (S15).

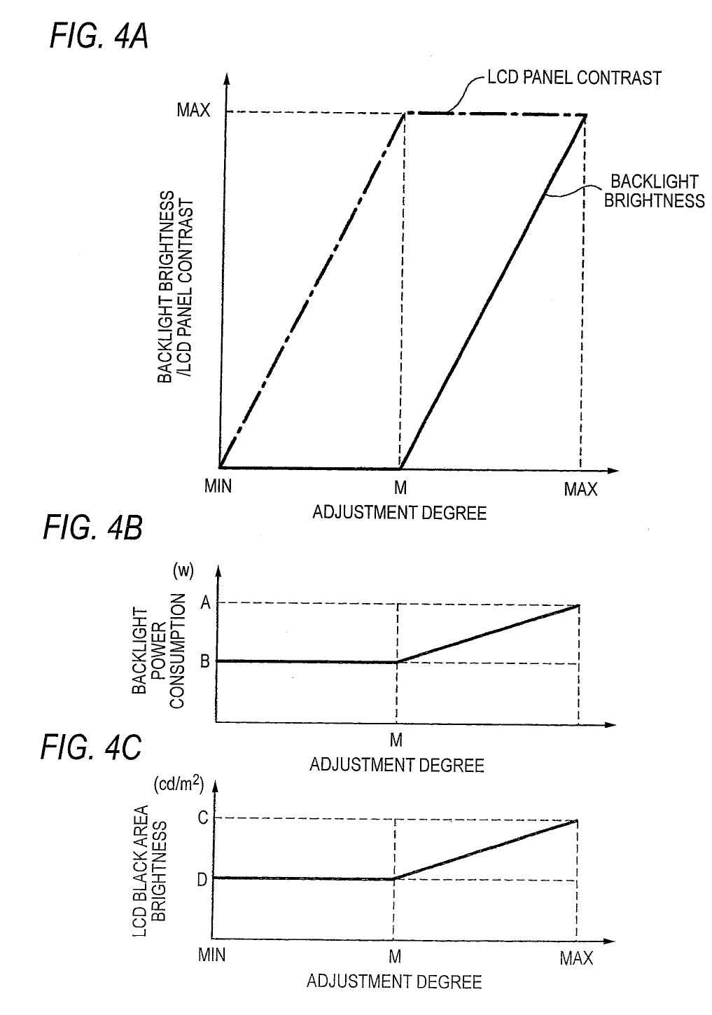

FIGS. 4A to 4C are graphs showing the operation of the liquid crystal display device according to the embodiment.

The operation of the remote controller 30 and input unit 30 is executed using two switches of e.g. a +button and a −button to change the adjustment degree. The brightness of the backlight 11A and the contrast of the LCD panel 12A are related with to the adjustment degree as shown in FIG. 4A.

As the adjustment degree is increased from the minimum value (MIN in FIG. 4A), the contrast value of the LCD panel 12A is increased. At the point where the adjustment degree becomes M, the contrast value becomes a maximum value (MAX). Thereafter, until the adjustment degree reaches a maximum value (MAX), the contrast value keeps its maximum value.

On the other hand, as the adjustment degree is increased from the minimum value, the brightness of the backlight 11A keeps its minimum value (MIN) and starts to increase from the point when the adjustment degree becomes M. When the adjustment degree reaches the maximum value, the brightness of the backlight 11A becomes its maximum value (MAX).

As described above, the brightness of the backlight 11A keeps its minimum value until the adjustment degree reaches M and increases after the adjustment degree of M. For this reason, as shown in FIG. 4B, the power consumption of the backlight 11A continues to keep “B” until the adjustment degree of M, and increases after the adjustment degree of M to reach “A”. Here, “A” represents the backlight power consumption when the brightness value of the backlight 11A is maximum, and “B” represents the backlight power consumption when the brightness value of the backlight 11A is minimum.

Likewise, as shown in FIG. 4C, the black (area) brightness in the LCD 10A continues to keep “D” until the adjustment degree of M, and increases after the adjustment degree of M to reach “C”. Now, “C” represents the black brightness of the LCD 10A when the brightness value of the backlight 11A is maximum, and “D” represents the black brightness of the LCD 10A when the brightness value of the backlight 11A is minimum.

(Advantage of the Embodiment)

In accordance with the embodiment of this invention, the backlight 11A and LCD panel 12A are controlled unitedly by the backlight/contrast adjustment 51 to determine the order of control for the backlight 11A and LCD panel 12A. For this reason, it is possible to avoid increases in the power consumption and black brightness which occur, for example, in adjusting the contrast of the LCD panel 12A when the brightness value of the backlight 11A is maximum. Further, improvement of the black brightness improves the contrast.

Further, since the adjustment for the backlight 11A and LCD panel 12A can be simultaneously managed by a single operation, the operation can be simplified.

Additionally, the contrast of the LCD panel 12A from the adjustment degree MIN to the adjustment degree MAX may have a feature that it changes not linearly but curvedly. Likewise, the brightness value of the backlight 11A from the adjustment degree MIN to the adjustment degree MAX may have a feature that it changes not linearly but curvedly. Further, the value of the adjustment degree may be set arbitrarily.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A liquid crystal display device comprising:
a display unit configured to display an image, the display unit including an LCD panel and a backlight;
an input unit at which an adjustment amount is input, the adjusting amount being used to adjust a contrast and a brightness of the image; and
a control unit configured to adjust a brightness of the backlight and a contrast value of the LCD panel based on the adjustment amount, the brightness of the backlight being adjusted when the contrast value is maximum, the contrast value being adjusted when the brightness of the backlight is minimum.

2. The liquid crystal display device according to claim 1,
wherein the control unit includes a contrast control unit configured to adjust the contrast value of the LCD panel and a backlight control unit configured to adjust the brightness of the backlight.

3. The liquid crystal display device according to claim 2,
wherein the input unit includes a switch configured to control an increase and decrease of a numerical value for adjusting the display unit.

4. A liquid crystal display device comprising:
a display unit configured to display an image, the display unit including an LCD panel and a backlight;
a contrast control unit configured to adjust the contrast value of the LCD panel;
a backlight control unit configured to adjust the brightness of the backlight;
an input unit at which an adjustment amount is input, the adjusting amount being used to adjust a contrast and a brightness of the image; and
a control unit configured to transmit a first control signal to the contrast control unit and a second control signal to the backlight control unit, the first control unit being transmitted to adjust the brightness of the backlight based on the adjusting amount when the contrast value is maximum, the second control unit being transmitted to adjust the contrast value based on the adjusting amount when the brightness of the backlight is minimum.

5. The liquid crystal display device according to claim 4,
wherein the input unit includes a switch configured to control an increase and decrease of a numerical value for adjusting the display unit.

6. A method of controlling a liquid crystal display device including an LCD panel and a backlight, the method comprising:
inputting a display adjustment degree;
determining a contrast value of the LCD panel and a brightness value of the backlight based on the adjustment degree;
adjusting the brightness value of the backlight when it is determined that the contrast value of the LCD panel is maximum; and
adjusting the contrast value of the LCD panel when it is determined that the brightness of the backlight is minimum.

7. The method according to claim 6,
wherein the step of adjusting the brightness value of the backlight includes transmitting a first control signal to a contrast control unit to enable the contrast control unit to adjust the brightness of the backlight; and
the step of adjusting the contrast value of the LCD panel includes transmitting a second control signal to a backlight control unit to enable the backlight control unit to adjust the contrast value of the LCD panel.
